(19) United States
(12) Patent Application Publication
(10) Pub. No.: US 2010/0031074 A1
(43) Pub. Date: Feb. 4, 2010

(54) Storage device and control method for the same

(75) Inventor: Hideaki Takahashi, Odawara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/232,654

(22) Filed: Sep. 22, 2008

(30) Foreign Application Priority Data
Jul. 30, 2008 (JP) 2008-197052

(51) Int. Cl. G06F 1/32; G06F 12/00; G06F 13/00; G06F 12/08

(52) U.S. Cl. 713/324; 710/305; 711/118; 711/E12.001; 711/E12.017

(57) ABSTRACT

In a storage device, any one of management sections respectively provided to a plurality of control modules is set to be in charge of collectively managing the modules, and a management user is allowed to collectively manage the modules via this management section through access thereto. Such a storage device is thus enabled, even if a control module is designed to be provided sequentially to a storage system, to manage the control modules as collective control resources with respect to a host device, and a method for controlling such a storage device is also provided.

### CROSS REFERENCES TO RELATED APPLICATIONS

This application relates to and claims priority from Japanese Patent Application No. P2008-197052, field on Jul. 30, 2008, the entire disclosure of which is incorporated herein by reference.

### BACKGROUND OF THE INVENTION

1. Field of the Invention

The present invention relates to a storage device and a control method therefor and, more specifically, to a control technology related to a grid storage system with excellent scalability.

2. Description of the Related Art

There exists a storage device storing data from a connected host computer such as server, and providing the data back to the host computer. Such a storage device is configured as a disk array device mainly carrying a plurality of hard disk drives (HDDs) arranged in an array. The host computer is higher in level than the storage device. As a control device configuring such a storage device, there exists a disk array control device configured by a plurality of disk array control units as described in Patent Document 1 (JP-A-2001-256003) below.

As one type of such a storage device, there exists a storage device designed to be able to sequentially enhance the data processing capability. For capability enhancement as such, the storage device modularizes a control device in charge of control associated with data transfer between a host device such as host computer and a memory device, and makes a user to sequentially add a plurality of resulting modules.

Such a storage device is known as a grid storage, and can increase the size of its own in accordance with amount of data to be handled by a user, i.e., is excellent in scalability. This accordingly offers advantages to the user of being able to avoid initial investment more than necessary.

The control device as a result of modularization, i.e., Disk Array Controller (DKC), operates itself as control resources of a type with respect to a host device. Even if such a modularized DKC is plurally connected, the resulting device operates not as control resources of a plurality of types but control resources of a type with respect to the host device.

The DKC is provided with a management section referred to as SVP (Service Processor). The management section does not handle data directly but is provided with a user interface for use of various types of management, e.g., makes a user to refer to failure information of the storage device, makes the user to set, change, and refer to configuration information of the storage device, and makes the user to refer to information related to maintenance of the storage device.

The problem with such a grid storage in which a plurality of DKC modules are connected, when the SVP of each of the DKC modules starts to individually operate, the grid storage cannot be managed as collective control resources.

### SUMMARY OF THE INVENTION

In consideration thereof, an object of the invention is to provide a storage device that can manage, even if a control module is designed to be sequentially provided to a storage system, the control modules as collective control resources with respect to a host device, and a method for controlling such a storage device.

In order to achieve the object, the invention is characterized in setting any one of a plurality of management sections respectively provided to a plurality of control modules to put it in charge of collectively managing the modules, and allowing a management user to collectively manage the modules via this management section through access thereto.

The invention can provide a storage device that can manage, even if a control module is designed to be sequentially provided to a storage system, the control modules as collective control resources with respect to a host device, and a method for controlling such a storage device.

### BRIEF DESCRIPTION OF THE DRAWINGS

FIG. 1 is a perspective view of a storage device in its entirety of the invention, showing the general view thereof;

FIG. 2 is a block diagram showing the hardware configuration of a storage system including the storage device of FIG. 1;

FIG. 3 is a block diagram for illustrating more in detail the configuration of components in the storage device of FIG. 2;

FIG. 4A shows an exemplary management table of information i.e., configuration information, power supply state information, and monitor information, under the management of a microprogram to be run by a typical MP-PK of DKC modules with an assumption that the storage device is configured by one module;

FIG. 4B shows another exemplary management table with an assumption that the storage device is configured by two modules;

FIG. 5 is a detailed flowchart of the operation of the storage device changing the mode of management devices of the DKC modules;

FIG. 6 shows an exemplary GUI (Graphical User Interface) screen for provision to a management server by an SVP in “active mode”;

FIG. 7 is a table showing whether various PKs in a processing device can be in a power saving mode or not, and if possible, implementations thereof;

FIG. 8 is a flowchart of an exemplary operation with an assumption that two DKC modules configure one storage device, i.e., a CM-PK is partially changed in mode from a general mode to a power saving mode in response to a variation of load to the CM-PK (CM turn-OFF process), and is changed in mode again from the power saving mode back to the normal mode (CM turn-ON process);

FIG. 9 is a detailed flowchart of the turn-OFF process executed by a control microprogram with respect to a cache memory package satisfying requirements;

FIG. 10 is a block diagram of a cache memory package:

FIG. 11 is a flowchart of a read process of the storage system;

FIG. 12 is a flowchart of a write process thereof; and

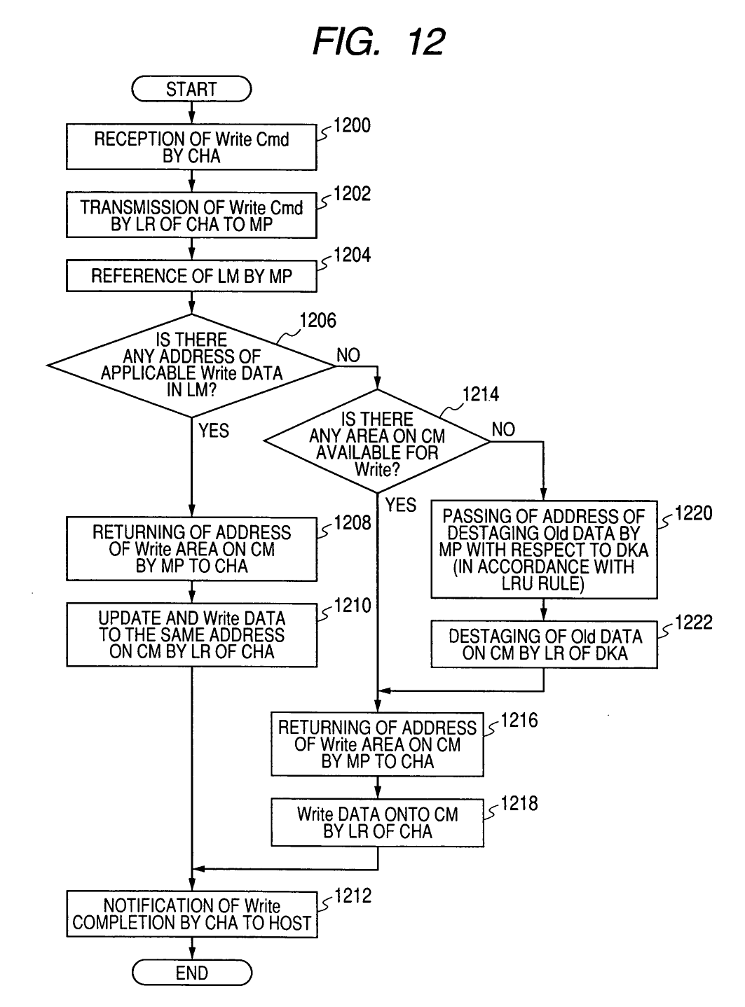

FIG. 13 shows a table of management information related to a copy process.

### DESCRIPTION OF THE PREFERRED EMBODIMENT

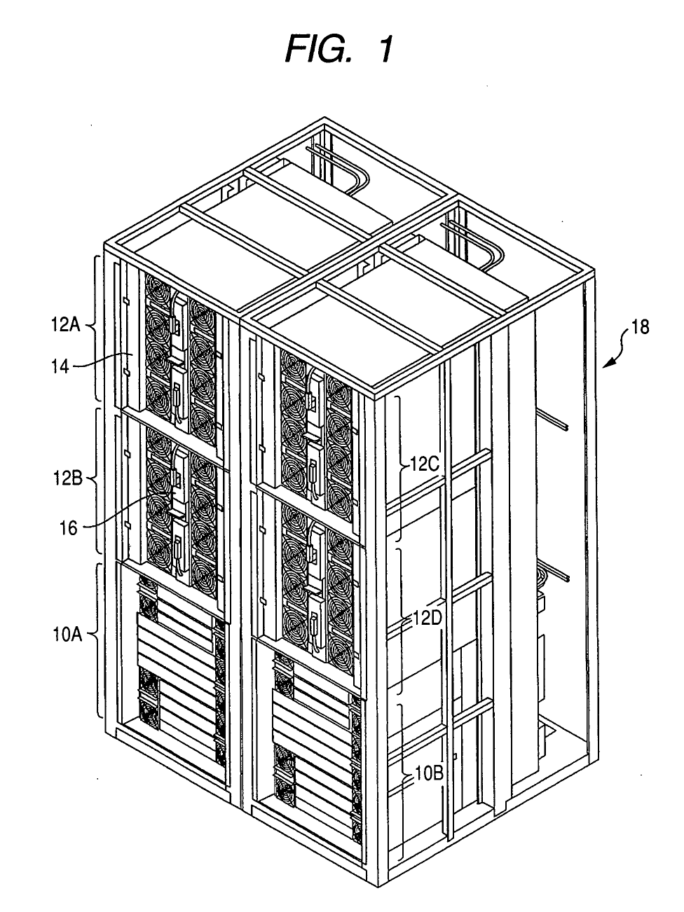

Described next is an embodiment of the invention. FIG. 1 is a perspective view of a storage device in its entirety of the invention, showing the general view thereof. This storage device is configuring a system by two DKC modules 10A and 10B connected together.

These two DKC modules are each attachably/detachably incorporated to a general-purpose frame 18 such as 19-inch standard rack. The storage device is provided with two DKU modules (12A, 12B), and (12C, 12D) respectively for the two DKC modules 10A and 10B.

The DKU modules are each a portion for storing user data coming from its corresponding DKC module, and are each configured by an SAS Switch (SSW) 14, and a power supply (PS) 16. The SSW 14 is the one corresponding to a data transfer protocol such as HDD-BOX and Serial Attached SCSI (SAS) configured by a nonvolatile storage medium such as hard disk drive. The storage resources are not necessarily an HDD, and may be a semiconductor memory such as flash memory. The SSW is mainly in charge of data transfer to the storage medium, and bypass control, failure notification, and others at the time of data reading from the storage medium to the DKC modules.

When a user request comes asking for increase of paths between the host, increase of storage capacity, and others, the DKC and DKC modules can be added or removed to/from the standard rack on a module basis.

The DKC modules can each independently function as a storage device with respect to a host device. That is, when the system is not incorporated with the DKC module 10B, the DKC module 10A can solely control data write and read commands coming from the host with respect to the DKUs 12A and 12B. On the other hand, when the DKC modules 10A and 10B are coupled together, thus coupled two DKC modules operate as a one-piece high-performance storage device. That is, for example, the DKC module 10B can process a command directed to the port of the DKC module 10A from the host, and the DKC module 10A can do the same with respect to a command directed to the port of the DKC module 10B.

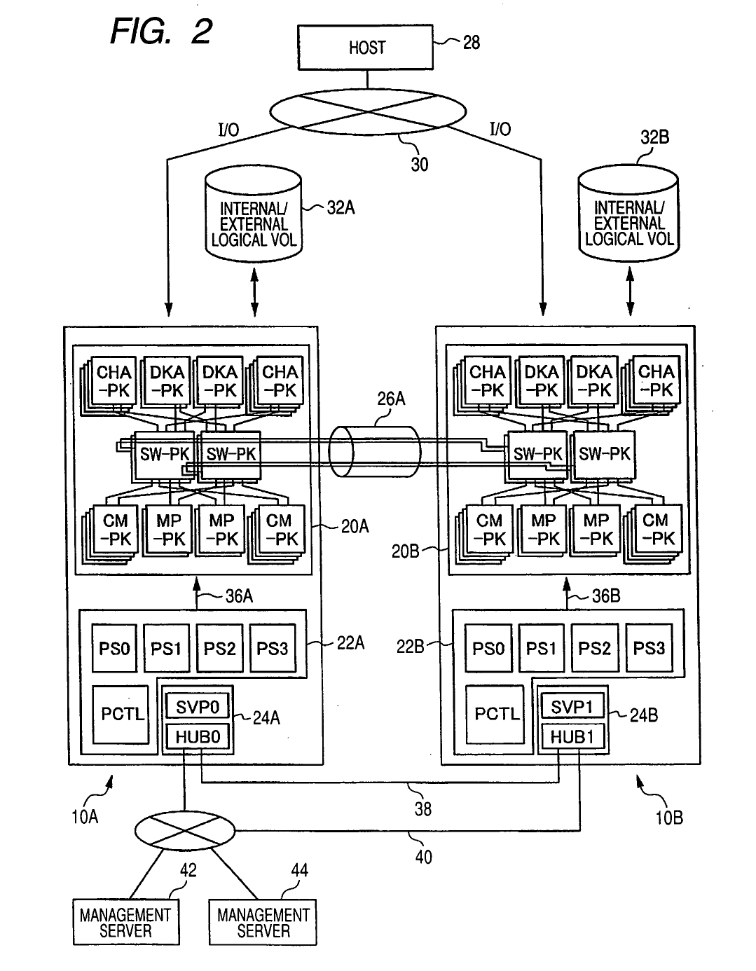

FIG. 2 is a block diagram showing the hardware configuration of a storage system including the storage device of FIG. 1. In the storage system, the DKC modules 10A and 10B are connected together by a path (X path) 26. The path 26 is the one implementing the internal bus architecture of a personal computer such as PCI (Peripheral Component Interconnect), preferably, a high-speed serial data transfer protocol such as PCI-EXPRESS. A host 28 is connected to the DKC modules 10A and 10B over a network 30 such as SAN (Storage Area Network).

The DKC module 10A (10B) is mainly classified into a processing device (CTL) 20A (20B), a power supply device 22A (22B), and a management device 24A (24B).

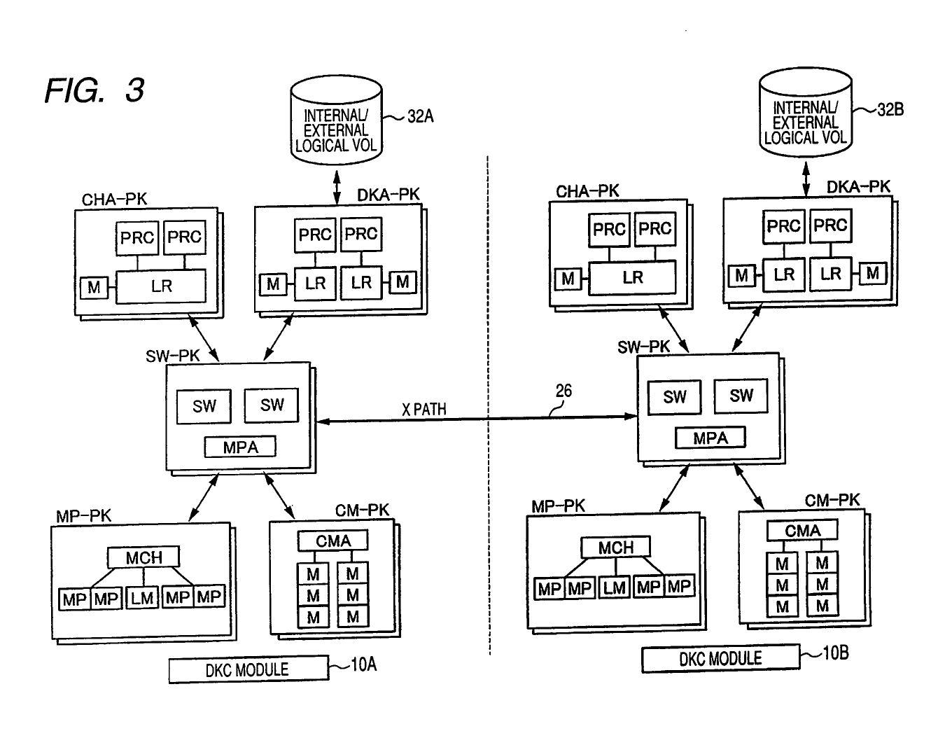

The CTLs (20A and 20B) are each a portion for actual data processing, and are each provided with the components of FIG. 2 (will be described later). FIG. 3 is a block diagram for illustrating the configuration of the components more in detail.

In the below, based on FIGS. 2 and 3, described are hardware components configuring the DKC module. The host 28 is connected to a channel adaptor package (CHA-PK) including a protocol chip (PRC) corresponding to a data protocol of the host. Herein, LR denotes a local router, and M denotes a volatile Memory DIMM (Dual Inline memory Module).

A disk adaptor package (DKA-PK) including a protocol chip corresponding to the data protocol of a storage medium is connected to each of the DKU modules of FIG. 1. Reference numerals 32A and 32B each denote an internal/external logical volume representing the storage area of the corresponding DKU. The internal logical volume is formed by the DKU connected to the DKC, and the external logical volume is formed by a memory device of any external storage system.

Moreover, the CTLs (20A and 20B) are each configured to include a cache memory package (CM-PK), a microprocessor package (MP-PK), and a switch package (SW-PK). The CM-PK is in charge of data buffering between the host 28 and a storage medium, and the MP-PK is in charge of command/computation process. The SW-PK is in charge of switching of data and commands among the various types of packages, i.e., CHA-PK, DKA-PK, CM-PK, and MP-PK.

In FIG. 3, CMA in the CM-PK denotes Cache Memory Adaptor, MCH in the MP-PK denotes Memory Controller Hub and LM therein denotes Local Memory, and MPA in the SW-PK denotes Micro Processor Pass Adapter. Data transfer among the components of the CTL is implemented by an internal high-speed data transfer protocol such as PCI-EXPRESS.

The CTL of each of the DKC modules is configured by a plurality of clusters in view of failure resistance. The clusters are each of a configuration in which the SW establishes a connection among the CHA, DKA, CM, and MP. The hardware resources of each of the CHA, DKA, CM, MP, and SW are packaged, and the resulting packages can be added or removed in accordance with the user's use environment or in response to incoming commands. Herein, “PK” denotes a package.

When these packages cannot be added to a first DKC module that is currently available, a second DKC module is added to the first DKC module, and the resulting DKC module may be added with any package as the user desires.

The path 26 between the two DKC modules described above is specifically formed between the SW-PKs of the DKC modules. In view of the failure resistance of the path, the path between the DKC modules is made redundant and includes a plurality of routes. Accordingly, in each of the DKC modules, a pair of SW packages is at least mounted, i.e., two SW packages, and a path is formed between any one of the SW packages of the DKC module 10A and any one of the SW packages of the DKC module 10B. Assuming that the DKC module includes a pair of SW packages, a path is formed for each of the SW packages.

By these two DKC modules being coupled together by the X path, the two DKC modules each become able to use the hardware resources of other DKC modules, and the storage system in which these two DKC modules are coupled can implement control resources of a type with a higher performance than with only one DKC module therein.

As an example, the MP of the processing device of one of the two DKC modules can access the components in the remaining DKC module, i.e., CM, CHA, DKA, and MP, via the SW and the path 26.

As such, the MP of one of the modules is allowed to access a pair of host paths under the control of the remaining module, i.e., hosts 28, and a pair of disk paths (internal/external logical VOLs) 32A and 32B. That is, the MPs each in charge of the command/computation process can each individually perform the command/computation process irrespective of whether the module is of its own or not.

For example, the management server is allowed to set logical units (LU) into the management table in advance. The LUs are those for connection to the port of a specific CHA for a host as component information of the DKC modules.

At the time of setting as such, the storage device is also allowed to define, with respect to the CHA port of the DKC module 10A, in the management table, any path for the LU(s) under the control of the remaining module 10B.

This is possible because the above-described X path makes the hardware resources available for the two DKC modules for shared use. The host 28 recognizes the DKC modules 10A and 10B as a single piece of storage device with no distinction therebetween.

The management devices 24A and 24B do not handle data directly, but are each provided with an interface for offering information about various types of management to management servers 42 and 44 each being a management client. The various types of management include making a user to refer to failure information of the processing devices 20A and 20B, making the user to set, change, and refer to configuration information of the processing devices, and making the user to refer to information related to maintenance of the processing device, for example.

As one of the main hardware components, the management device manages management information, and includes an SVP (service Processor) serving as an interface with the user, and a HUB for LAN communications between an SVP0 of the first DKC module 10A and an SVP1 of the second DKC module 10B. For the purpose of preventing any SVP failure from affecting the coupling between the management devices of the two DKC modules, the SVP of one of the DKC modules is coupled with the SVP of the remaining module over the HUB.

Between a HUB0 of the first DKC module and another HUB1 of the second DKC module, a LAN 38 is formed for direct communications between the modules. The HUB0 and HUB1 are connected to a LAN network 40, which is connected with first and second management servers 42 and 44.

When a plurality of DKC modules are coupled together, the management devices to be also coupled are put into the relationship of master/slave of active/standby. That is, any one of a plurality of SVPs is set in an active mode, and the remaining SVPs are set in a standby mode.

The SVP in the active mode is allowed to refer to and change the management information of its own module through access thereto, and to set any new management information. The SVP in the active mode is also allowed to access the management information of any other modules through access to the SVPs thereof in the standby mode over the LAN 38.

Assuming that the SVP0 is in the active mode, management information collected from the processing device 20A of the DKC module 10A, i.e., the SVP0 is belonging thereto, is combined, for collective management, with information collected from the remaining processing device 20B of the DKC module 10B, i.e., the SVP1 in the standby state is belonging thereto. The resulting combined information is forwarded to a management user.

On the other hand, the SVP1 in the standby mode does not normally access the management information of the modules irrespective of whether the module is of its own or not. Instead, the SVP1 in the standby mode acquires, from the SVP0 in the active mode, every management information of the active SVP0 at regular intervals over the LAN 38. As such, the SVP in the standby mode is in synchronization with the SVP in the active mode.

The SVP in the active mode includes an interface (I/F) with the management user, and the user accesses the SVP in the active mode so that the storage device in which the two DKC modules are coupled together can be managed as a single piece of DKC.

The relationship between active and standby is dynamically changed in the management device, and sometimes the SVP in the active mode may be changed into the standby mode, and the SVP in the standby mode may be changed into the active mode.

The cue for such a state change is when any setting change is made to the SVP or when any failure occurs to the SVP in the active mode, for example. When any failure occurs to the SVP in the active mode, this SVP is changed in mode to standby, and the SVP originally in the standby mode is changed in mode to active. The storage system of FIG. 2 can thus operate in such a manner as to continuously keep the management device in which a plurality of DKC modules are collectively managed with respect to the management user.

In order to allow a user to collectively manage a plurality of DKC modules via the SVP in the active mode, described next is the method for disguising a plurality of management systems in active/standby mode as a piece with respect to the management servers 42 and 44.

A manager of the storage system determines in advance an IP address for the SVP in the active mode to be unique, and the management server is so configured as to access the IP address of the SVP in the active mode.

When the active/standby mode change is made among a plurality of SVPs, an IP address change is also made thereamong so that the SVP in the active mode is provided with the IP address determined in advance.

Assuming that the SVP in the active mode is provided with an IP address of “***.***.***.15” in advance, the management server is so configured as to always access the IP address of “***.***.***.15”.

When the SVP0 of the DKC module 10A is in the active mode, and when the SVP1 of the DKC module 10B is in the standby mode, the SVP0 has the IP address of “***.***.***.15”, and the SVP1 has the IP address of “***.***.***.14”, for example.

As will be described later, when a mode change between active and standby is required for a plurality of SVPs with some reason, e.g., a failure occurs to the SVP0, the SVP1 newly changed in mode to active changes the IP address of the SVP0 to “***.***.***.14”, and changes the IP address of its own to “***.***.***.15”.

As a result, a plurality of management servers recognize the SVP in the active mode, i.e., the SVP having a specific value of “***.***.***.15” as the IP address, but not any other SVPs in the standby mode.

Note that the SVPs each provide the following functions to the management user (management server). The functions include referring to and changing component information of the storage system and information set by a user, referring to failure information of the storage system, referring to an user I/F and monitor information, setting and referring to a hardware platform (Web engine function) of various types of user management applications, and referring to the power supply state information. The user I/F is the one for maintenance operation of the storage system, e.g., device operation user I/F at the time of failure portion exchange operation and recovery operation. The monitor information is about hardware operating state such as port IOPS (I/O per Second), CM use rate, MP use rate, and LEDV IOPS.

The configuration information is about the hardware resources incorporated in the DKC modules, e.g., whether there are any hardware resources, and if any, the type thereof. More specifically, the configuration information includes the number of CM-PKs (cache memory packages) to be optionally added by a user, the type and capacity of a cache memory to be mounted to the CM-PK, the type and number of CHAs, the user's unique setting value, and others. Such configuration information is handled by the microprogram of the processing device.

The configuration information is stored, when the DKC modules are not in operation, in a nonvolatile memory such as flash memory of the MP-PK, and for backup purpose, in a nonvolatile medium such as hard disk of the SVP.

The configuration information is loaded from the nonvolatile memory of the MP-PK to the volatile local memory (LM) of the MP-PK in response to when the storage device is activated. The configuration information of the LM is updated to be the latest as the need arises, and when the device is not in operation as planned, the information is stored in a nonvolatile flash memory in each of the MP-PKs during a process with the device stopped as planned (hereinafter, referred to as planned-stop process).

The power supply state information is about the power supply state on a package basis. The packages can be each in the power saving mode. When accessing various types of packages of its own DKC module or of any other DKC modules, the MP-PK is required to know in advance the power supply state of the packages.

The power supply state information is managed in a specific memory area in the LM of the MP-PK. The specific memory area is the one reserved, after activation of the DKC modules is completed, when the power saving mode function in the microprogram, i.e., JOB, starts operating.

The power supply state information is managed by the power saving mode function, i.e., JOB, while the device is being activated, and is regularly updated. When the device is not in operation as planned, the power supply state information is not needed to be stored, thereby being volatilized at the timing when the power is turned OFF after the planned-stop process.

The monitor information is stored in the LM of the MP-PK. Similarly to the power supply state information, the monitor information is managed in a specific memory area in the LM of the MP-PK. The specific memory area is the one reserved, after activation of the device is completed, when the monitor function in the control microprogram, i.e., JOB, starts operating.

The monitor information is managed by the monitor function, i.e., JOB, while the device is being activated, and is regularly updated in accordance with the state thereof. When the device is not in operation as planned, the monitor information is not needed to be stored, thereby being volatilized at the timing when the power is turned OFF after the planned-stop process.

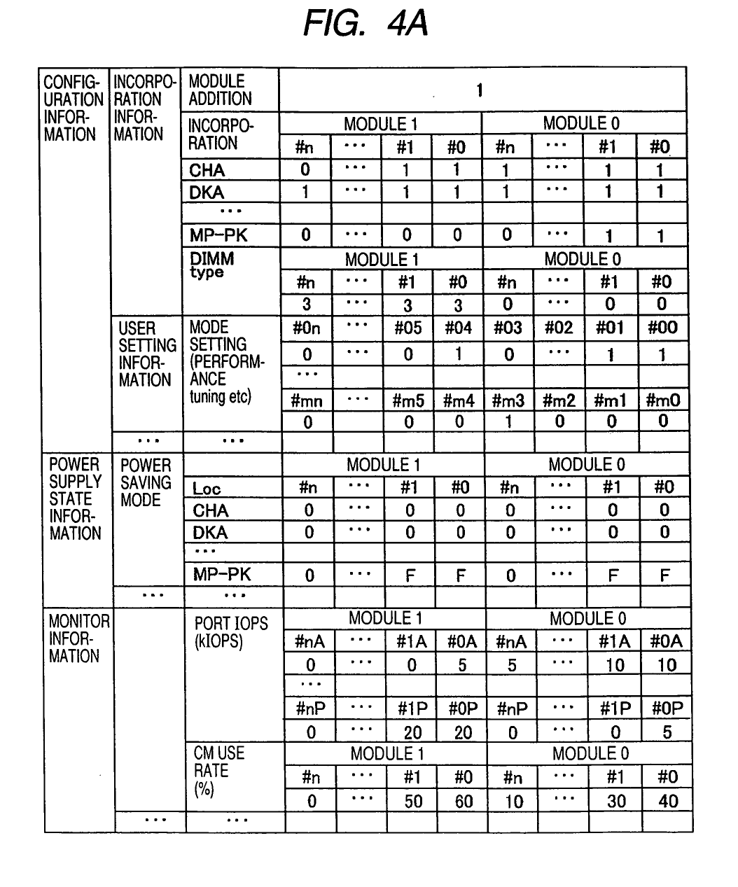

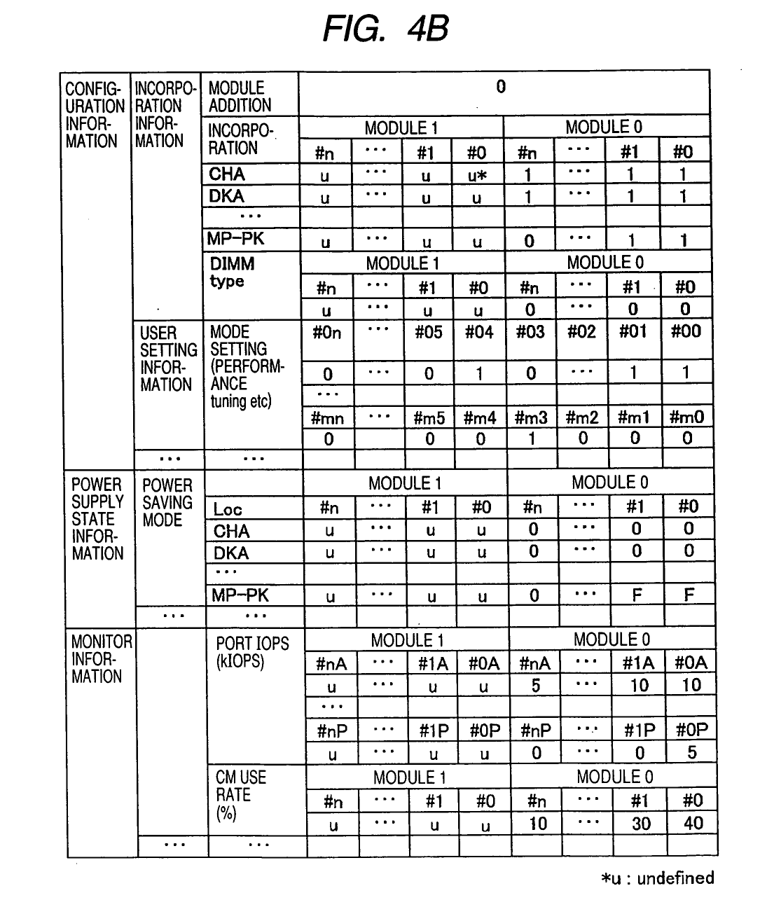

FIGS. 4A and 4B are each an exemplary management table of various types of information, i.e., configuration information, power supply state information, and monitor information, under the management of a microprogram to be run by any typical MP-PK of the DKC modules. Specifically, FIG. 4A shows a table with an assumption that the storage system is configured by one module, and FIG. 4B shows another exemplary management table with an assumption that the storage system is configured by two modules.

When the storage system is of a grid configuration including a plurality of modules, the MPs of every MP-PK found plurally in the modules each separately run the microprogram.

Such management tables are stored in each of the LMs of all of the MP-PKs. The MPs each know in advance the information of shared use, e.g., management table, and can operate each separately. For accessing any specific hardware resources, the MPs are each required to know in advance whether there is any hardware being the access destination, the state of the power saving state, and others. Therefore, the MPs each include, e.g., in the LM, the configuration information, the power supply state information, and others. For addition of modules, in the “incorporation information” of FIG. 4A, a bit of “module addition” is turned on, and as shown in FIG. 4B, various types of information, e.g., configuration information, is reflected and updated in the table area of a module 1.

In FIG. 2, the DKC module 10A (10B) includes the power supply device 22A (22B). The power supply device is provided with four power supplies of PS0 to PS3, and a Power Controller (PCTL) for use of power supply control. From such a power source device, a power supply is made to components of the processing device such as CHA-PK, and the management device.

The number of the power supplies provided to each DKC module is four at the maximum and two at the minimum. Each of the power supplies carries therein two DC (Direct Current)-DC converters so that the two power supplies can form four power boundaries in total. Accordingly, when the number of the power supplies is two being the minimum, even if one of the Converters is broken down, four power boundaries can be maintained. In the drawing, reference numerals 36A and 36B each denote a control signal for use of power supply control between the PCTL, the power supplies, and the processing device.

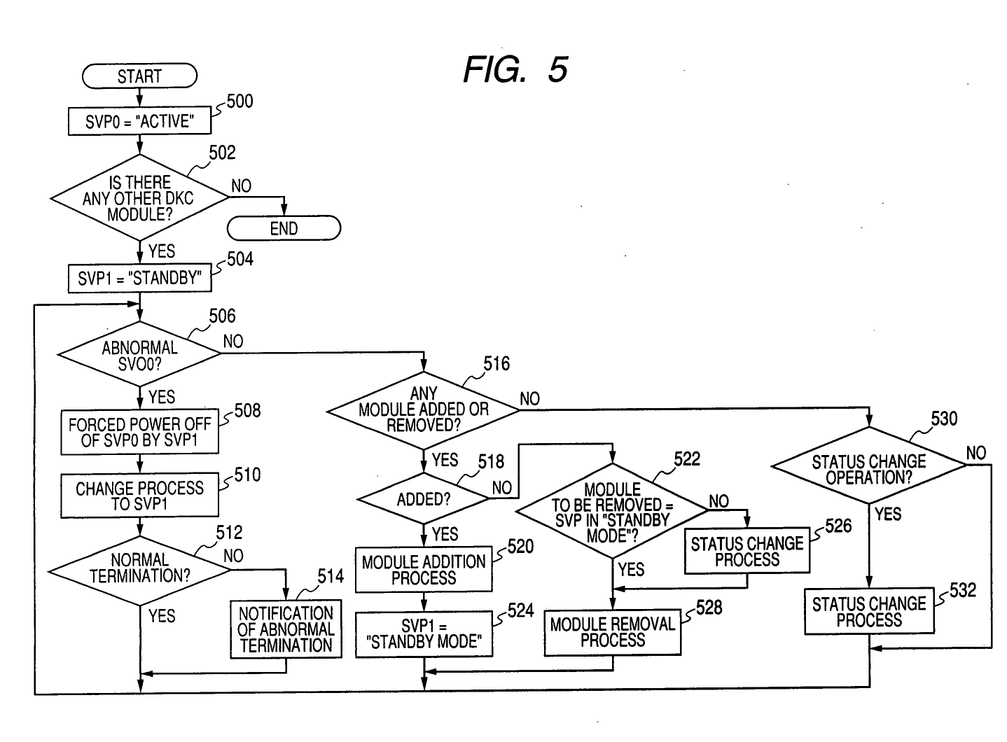

Described next is the operation of the storage system changing the mode of the management devices in a plurality of DKC modules. FIG. 5 is a detailed flowchart of the operation. A manager of the storage system sets “active mode” to the SVP0 of the DKC module 10A (500). For such mode setting, because the SVP is provided with a predetermined control flag, this flag is set with “active mode” or “standby mode”. The SVP checks this control flag to determine its own mode, and operates to suit the mode.

The manager then determines whether the DKC module 10A is connected with any other DKC modules (502), and when the DKC module 10B is connected thereto as shown in FIG. 2, the determination result is positive, and the SVP1 is set with “standby” (504). On the other hand, when the determination is negative, this is the end of the flow.

Between the SVP0 and SVP1, a heartbeat packet is being transferred over the LAN 38, and when the SVP1 cannot detect any heartbeat from the SVP0, the SVP1 determines that something is wrong with the SVP0 with some reason (506).

Thereafter, the SVP1 forcefully turns OFF the power supply of the SVP0 over the LAN 38 (508), and changes its own status from “standby mode” to “active mode” (510).

When such status change is normally completed, a process is executed to change the management right of the storage system from the SVP0 to the SVP1 (510). When such a process cannot be normally completed, the SVP1 notifies the manager of the storage system of abnormal termination (514). By the SVP0 being turned OFF, the abnormal mode is reset to the normal mode, thereby preventing any possible conflict between the SVP0 and SVP1 in terms of the management right of the storage system.

Note that, because the HUB of the DKC module 10A is operating separately from the SVP0 currently being abnormal, the SVP1 of the DKC module 10B thus can access various types of hardware resources, e.g., not only the PCTL of the DKC module 10B but also that of the DKC module 10A.

When the SVP0 is not abnormal, and when a DKC module addition is performed in the storage system (516, 518), in accordance with the addition of the DKC module, the manager sets “standby mode” to the SVP1 of the added module (520, 524).

On the other hand, when any DKC module is removed from the storage system (518), a determination is made whether the SVP of thus removed module is in “standby mode” or not (522), and when the determination result is positive, the module removal process is executed. When the SVP of the removed module is determined as being in “active mode”, the SVP of the module to be removed is in “standby mode”. In view thereof, the module removal process is executed after the SVP of the to-be-removed module is changed to “active mode” (526).

For a status change of the SVP in “standby mode” to “active mode”, and for a status change of the SVP in “active mode” to “standby mode”, the user can execute the status change operation from the SVP in “active mode” to the SVP in “standby mode”.

When transferring of the management information is started, over the LAN 38, from the SVP in “active mode” to the SVP in “standby mode”, and when such transferring is normally completed, a synchronization is established between the management information in the SVPs, whereby the SVPs are changed in status mode between the modules.

Herein, in a case where there are two DKC modules as in FIG. 2, the user may voluntarily perform the status change between these two SVPs (530, 532), e.g., at the time of hardware maintenance.

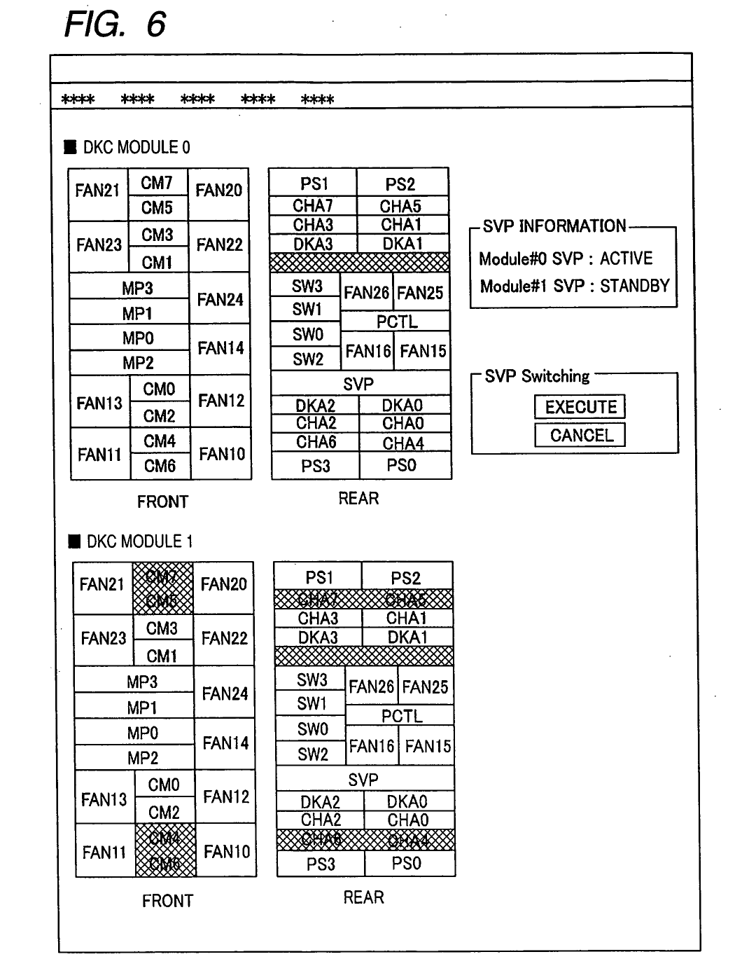

FIG. 6 shows an exemplary GUI (Graphical User Interface) screen to be provided to a management server by the SVP in “active mode” during the user's SVP status change operation. Such a change operation is possible only from the SVP in “active mode”.

On the GUI screen of FIG. 6, for each of the DKC modules, the device configuration and the state of devices are visually available for the user both on the FRONT and REAR sides. The shaded portion therein indicates that the component is not yet incorporated. If some component is abnormal, the abnormal portion thereof can be specified with ease by blinking display in the component.

The information about the SVP status is displayed on the GUI screen as shown in the drawing, thereby enabling the user to easily determine which SVP of the modules is in “active mode” or “standby mode”. The operation for such a status change is also possible on the GUI screen.

As described in the foregoing, when a plurality of modules are coupled together, and when the hosts share the hardware resources of the modules, power-saving measures are preferably taken for the hardware resources of the modules under the light load state, i.e., the I/O (Input/Output) frequency is low from the host to the modules.

To take such power-saving measures, the power saving mode is turned ON/OFF on a package basis of the hardware resources. The power saving mode means reduction of the CLK frequency and change to standby mode on an MP basis if with an MP-PK, and if with a CM-PK, means change to standby mode on a memory DIMM basis.

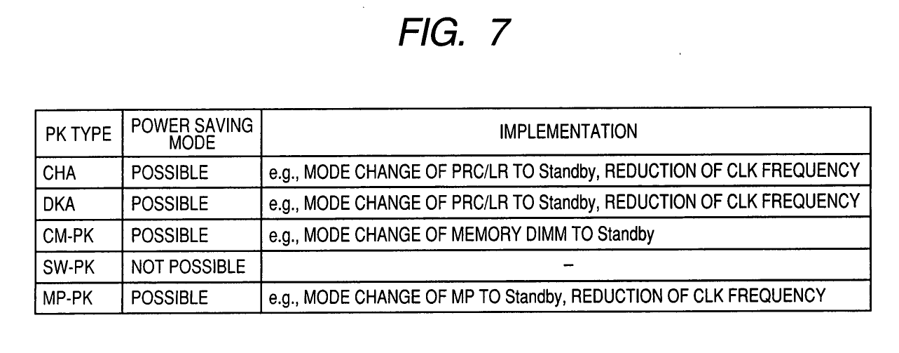

Alternatively, as the power saving mode, the power to be supplied to the PK may be turned ON/OFF at the input end of the PK, or the power to the PK may be turned ON/OFF at the output end of the AC (Alternating Current)-DC. FIG. 7 shows whether the various PKs in the processing device can be in the power saving mode or not, and if possible, the implementation thereof.

Such ON/OFF change control over the power saving mode on a PK basis can be implemented by a microprogram to be run by any one MP-PL being typical among others in the storage device configured by the DKC modules 10A and 10B.

For such ON/OFF change control over the power saving mode, various types of information are in need, i.e., device configuration information, monitor information, device failure information, and others. The control microprogram refers to such information to perform status change control.

In the PKs, the SW-PK cannot be changed into the power saving mode. As for the CM-PK, for example, the use rate thereof varies depending on state of load, and thus the CM-PK can be changed in mode to power saving when the use rate is low. The issue here is that, in the SW-PK, data switching is performed first of all in its own DKC module among CHA, DKA, CM-PK, and MP-PK, and thereafter performs data switching between the DKC modules. Therefore, unlike the CM-PK, the SW-PK cannot be selectively changed in mode to power saving.

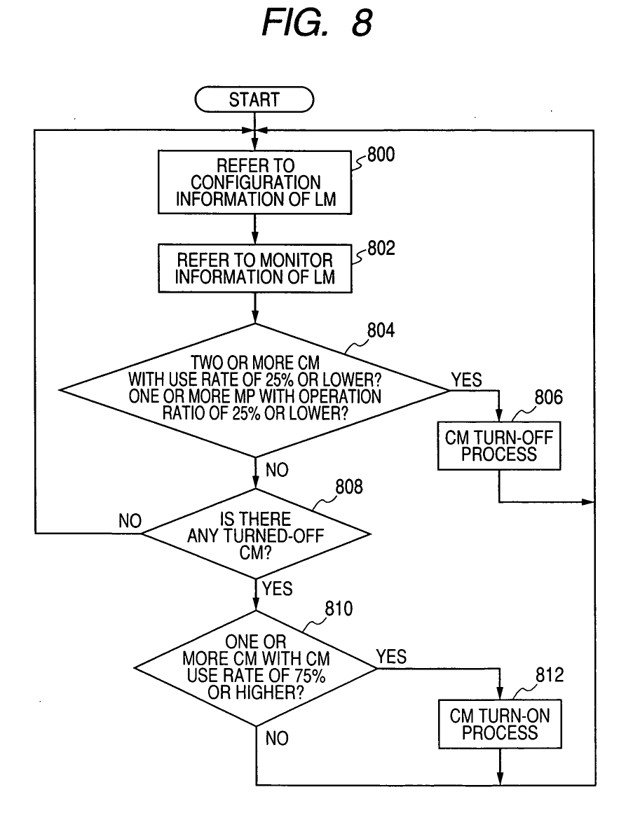

By referring to a flowchart of FIG. 8, described next is an exemplary operation in a case where two DKC modules configure a storage system, i.e., the CM-PK is partially changed into power saving mode in response to variation of load to the CM-PK (CM turn-OFF process), and the mode is reset from power saving to normal (CM turn-ON mode). That is, described is the operation flow of the CM turn-ON/OFF process in this case.

Exemplified here is a case where two DKC modules are connected together as in FIG. 2, and the SVP0 in the management device of the DKC module 10A is in “active mode”, and the SVP1 in the management device of the DKC module 10B is in “standby mode”.

The typical MP-P runs a control microprogram, and refers to the configuration information in its own LM (800). The MP-PK acquires monitor information in the LM, i.e., the port IOPS, the CM use rate, the MP use rate, LEDV, IOPS, and others (802).

The MP running the control microprogram determines whether there are two or more CM-PKs with the use rate of 25% or lower, and whether there are one or more MP-PK(s) with the operation ratio of 25% or lower (804).

Assumed here is that the CM-PKs of the DKC modules 10A and 10B each have the use rate of 25% or lower, and any one of the MP-PKs of the DKC module 10A has the operation rate of 25% or lower.

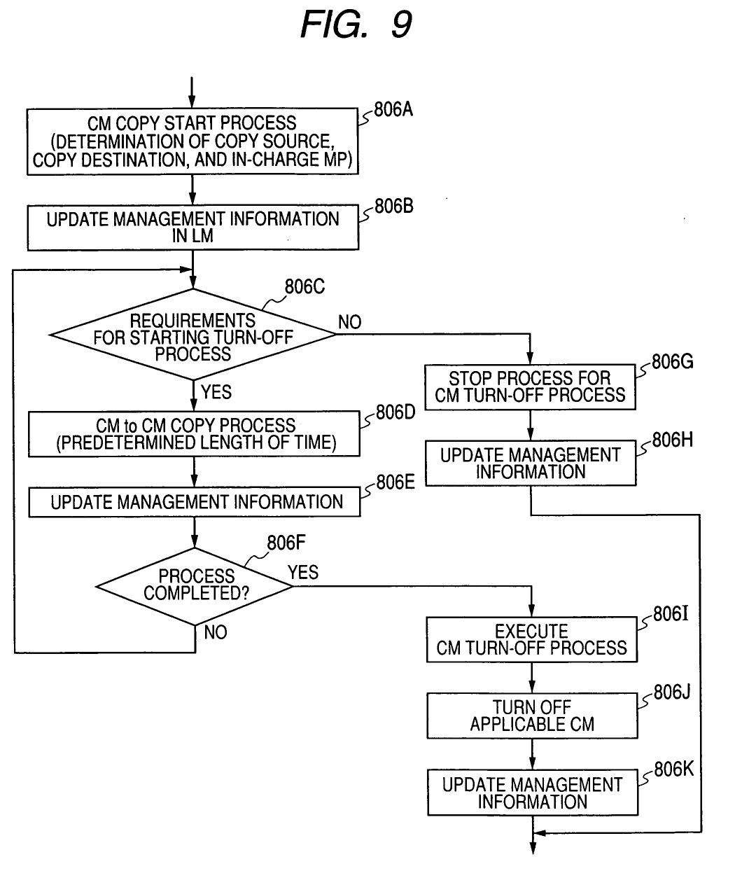

The control microprogram executes the turn-OFF process for the CM-PK satisfying the requirements (806). FIG. 9 shows the details of this process. Data copy is then started to any CM-PK not turned OFF from the turned-OFF CM-PK (806A). The control microprogram updates and then enters the management information about such a copy process in the LM as the management information in the LM (806B).

The management information about the copy process is mainly configured by a management ID, a copy completion flag, copy source information, and copy destination information. The management ID is provided to every segment of copying data. The copy source information includes segment-basis DKC module ID, and cache address, and the copy destination information also includes segment-basis DKC module ID, and the cache address.

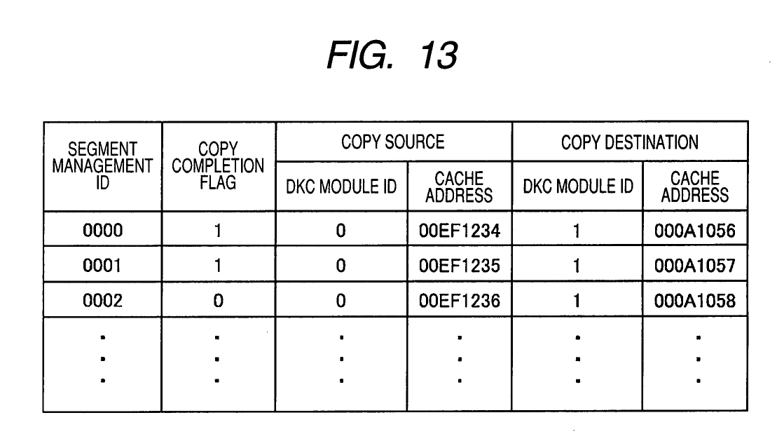

After completion of the copy process, the management information of any segment cleared with the copy completion flag is cleared and updated every time any new management information is entered as the need arises. FIG. 13 shows the management information table for use in such a copy process.

Prior to start the copy process, the control microprogram sets an address to both data copy source and destination, and determines an MP-PK in charge of the copy process. In this example, the copy source is the CM-PK of the DKC module 10B, the copy destination is the CM-PK of the DKC module 10A, and the MP-PK in charge is the MP-PK of the DKC module 10A.

When the control microprogram starts copying of data, in accordance with the requirements of 804 described above, the procedure of 806C to 806E is repeated until the process is completed, i.e., until the above-described copy completion flag is completely turned ON (806F). In 806C, a determination is made about the requirements for starting the turn-OFF process, and in 806D, data copying is performed from a CM to another CM during a fixed length of time. In 806E, the management information about the copy process in the SVP, i.e., SVP in active mode, in the management device is updated.

The reason of setting a predetermined length of time for data copying is that the CM use rate, the MP use rate, and others vary dynamically depending on the user's state of use, and thus the determination of “806C” about the requirements for starting the turn-OFF process is required to be considered at regular intervals.

When the control microprogram determines that the data copying is completed, the mode is changed to power saving with which the CM-PK being the copy source, i.e., CM-PK of the DKC module 10B, is turned OFF (806I, 806J).

Moreover, in the control microprogram, the power saving mode of the CM-PK being the copy source is updated and entered in the management information in the LM (806K).

When determining that the requirements for stating the turn-OFF process are not satisfied during the process of repeated copying related to the CM-PK, the control microprogram immediately terminates the turn-OFF process (806G), and updates the management information (806H). That is, the management information about the copy process of FIG. 13 is entirely cleared, thereby entirely clearing the tasks of copying.

When determining negative in step 804, when determining there is a turned-OFF CM-PK(s) (808), and when determining that there is one or more CM-PK(s) having the use rate of 75% or higher (810), the control microprogram goes through a process of turning ON the turned-OFF CM-PK(s) (812).

When the CM-PK being the copy destination is turned ON, the management information in the LM of all of the MP-PKs is updated, thereby making available the CM-PK of the DKC module 10B that has been turned OFF. As a result, the CM use rate that has been exceeded 75% is favorably reduced. Note here that the configuration information and the power supply state information in the management table of FIG. 4A are provided to each of the MP-PKs. With each of the MPs provided with such information, the MPs can operate each separately.

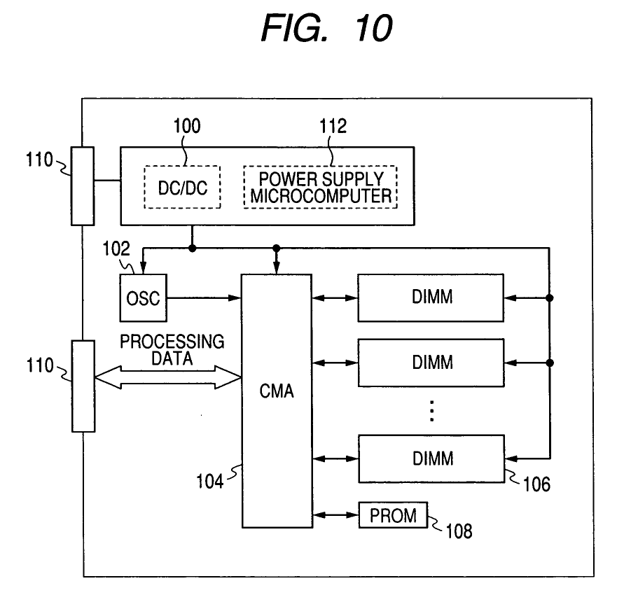

Described next is the power saving mode of the CM-PK. Assumed here is that the standby mode of the memory DIMM of the CM-PK is the power saving mode. FIG. 10 is the block diagram showing the internal configuration of the CM-PK. In the drawing, a reference numeral 100 denotes a DC/DC converter, and a reference numeral 102 denotes an Oscillator. A DIMM (Dual Inline Memory Module) 106 is connected to a cache memory adaptor (CMA) 104.

A reference numeral 108 denotes a PROM (Programmable Read Only Memory). The PROM stores PK unique information, e.g., version information and component information. A reference numeral 110 denotes a backboard connector, and a reference numeral 112 denotes a microcomputer in charge of control over the power supply. The backboard connector and the CMA exchange processing data to be temporarily stored.

When the memory DIMM is in the standby mode, the components other than the power supply section (power supply microcomputer included) and the memory DIMM, e.g., LSI (Large-Scale Integration), are turned OFF, and with a minimum-required refresh cycle not to allow deletion of data in each memory DIMM, the components are repeating the refresh operation for their own.

The power saving mode for the memory DIMM is referred also to as self refresh mode, and this self refresh mode is used also with a backup mode for the cache memory in the event of a power failure.

Described now is the flowchart of a read/write process when a plurality of DKC modules configure one storage system. Among a plurality of DKC modules, any typical MP-PK runs the control microprogram, and by referring to and managing the configuration information and the power supply state information in the LM, executes the read/write process irrespective of whether there is any package in the power saving mode or not.

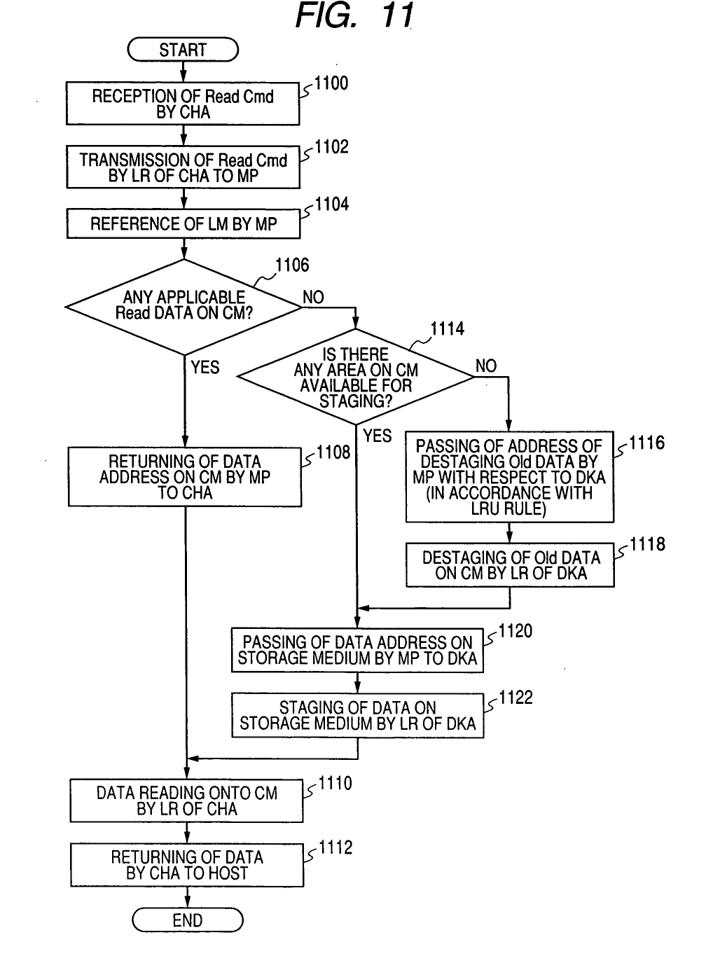

FIG. 11 is a flowchart of the read process. The CHA receives a read command from the host (1100). The LR of the CHA refers to the management table stored in the memory under the management of the LR, and determines the MP-PK in charge of processing this read command. The LR then forwards the read command to the MP-PK in charge as in step 1102. This is referred to as routing.

The management table in the memory of the LR stores information for use to associate the MP in charge with respect to a Logical Unit (LU) being a management unit of the logical volume. Using the management table, the LR can specify the LU from the address of the read command, thereby being able to determine the MP in charge.

The information in the management table of the LR is loaded from the LM of the MP at the time of device activation, and the information is updated when the need arises at the timing when the device configuration and the power supply state information are changed. The change of device configuration includes addition/removal of CHA/DKA/MP-PK, change of a pair of host paths, and others. Accordingly, for the MP-PK in the power saving mode, for example, the MP-PK is regarded as not existing in view of configuration, and thus no command routing is performed.

For the LR to determine the MP in charge, there is nothing to do with whether the in-charge MP is located in the original DKC module or in the adding DKC module. The hardware resources in all of the modules are shared by the X path between any two modules with no concern about the boundary of the modules.

The type of the PKs that can be changed in power saving mode is as described above, i.e., the PKs other than the SW-PK. The SW-PK is in charge of data switching between the hardware resources in and between the modules, and at the time of device activation, the SW-PK is always in the active mode.

The MP provided with the read command from the LR refers to the LM (1104). The LM of the MP stores address information of the data of the CM under the management of its own. The MP determines whether there is any read data on the CM by referring to the address information found in the command (1106).

When there is any read data on the CM, the MP returns the address of the data on the CM back to the CHA from which the command is provided (1108). When there is no such read data on the CM, the MP determines whether there is any area on the CM available for staging of the read data or not (1114).

When there is any area on the CM available for staging of read data, the MP passes, to the DKA, the address information about the read data found on the storage medium (1120).

When there is no such area on the CM available for staging of read data, the MP passes, to the DKA, the address of data (old data) currently not used at all for destaging in accordance with the least recently used (LRU) rule (1116).

After receiving the address of the old data from the MP, the LR of the DKA destages the old data on the CM onto the storage medium (1118).

Based on the address information on the storage medium provided by the MP, the LR of the DKA stages the data on the storage medium onto the CM (1122). The LR of the CHA reads the read data on the CM (1110). The CHA then returns the read data to the host (1112).

Described next is the write process. The CHA receives a write command from the host (1200). The LR of the CHA refers to the management table stored in the memory under the management of the LR, and determines the MP in charge of processing this write command. The LR then forwards the write command to the MP in charge (1202). The management table in the memory of the LR stores information for use to associate the MP in charge with respect to a Logical Unit (LU). Using the management table, the LR can specify the LU from the address of the write command, thereby being able to determine the MP in charge. The CHA-PK provided with the write command may be the one belonging to the DKC module 10A, or the in-charge MP-PK may be the one belonging to the DKC module 10B. The CHA-PK provided with the write command may be the one belonging to the DKC module 10B, or the in-charge MP-PK may be the one belonging to the DKC module 10A.

After receiving the write command from the LR, the MP refers to the LM (1204). The LM of the MP stores address information of the data of the CM under the management of its own. By referring to the address information found in the Cmd, the MP determines whether there is any address of the write data on the CM (1206).

When there is such an address of write data on the management table of the LM, the MP returns the same address as that of the writing area on the CM back to the CHA from which the command is provided (1208).

The LR of the CHA updates and records the data to the same address on the CM (1210).

When there is no such address of the write data on the management table of the LM (1206), the MP determines whether there is any area on the CM available for writing or not (1214).

When there is such an area on the CM available for writing, the MP passes, to the DKA, the address information about the area available for writing (1216). When there is no such area on the CM available for writing, the MP passes, to the DKA, the address of data currently not used at all for destaging (1220).

After receiving the address of the old data from the MP, the LR of the DKA destages the old data on the CM onto the storage medium (1222). The LR of the CHA then writes the data onto the CM (1218). The CHA notifies the host of completion of the writing (1212).

In the embodiment above, exemplified is the system in which two DKC modules are coupled together. This is surely not restrictive, and the invention is applicable to a system in which three or more DKC modules are coupled together.

What is claimed is:

1. A storage device configured to be able to modularize control resources for processing read and write commands coming from a computer with respect to storage resources, include at least one resulting module, and sequentially add any other resulting modules to the at least one resulting module, the storage device comprising:
a connection path that connects the plurality of modules under standards of high-speed internal bus;
a management network that establishes a connection among management sections of the plurality of modules; and
a management device that is connected to the management network, wherein
the management device includes an interface that accesses any of the management sections being in charge of collectively managing the plurality of modules.

2. The storage device according to claim 1, wherein
the standards of high-speed internal bus are PCI (Peripheral Component Interconnect)-EXPRESS.

3. The storage device according to claim 1, wherein
at least one of the plurality of management sections is set in an active mode, and remaining of the management sections are set in a standby mode, and
the in-charge management section is the management section set in the active mode.

4. The storage device according to claim 1, wherein
any one of the plurality of modules being a second module receives the read or write command directed to any one of the plurality of modules being a first module from the computer via the connection path for command processing.

5. The storage device according to claim 4, wherein
the first and second modules each include:
a first adaptor connected to the computer;
a second adaptor connected to the storage resources;
a cache memory that temporarily stores data to be transmitted/received to/from the computer;
a microprocessor that processes the command coming from the computer via the first adaptor; and
a switch that connects together the first and second adaptors, the cache memory, and the microprocessor.

6. The storage device according to claim 5, wherein
the connection path is formed between the switches of the first and second modules.

7. The storage device according to claim 3, wherein
among the plurality of modules, the management section of the first module is set in the active mode, the management section of the second module is set in the standby mode, the management section of the first module acquires management information of the second module from the management section of the second module, and the acquired management information of the second module is stored together with management information of the first module.

8. The storage device according to claim 7, wherein
the management section of the first module copies the stored management information into the management section of the second module.

9. The storage device according to claim 7, wherein
the management section of the first module is changed from the active mode to the standby mode, and in response thereto, the management section of the second module is changed from the standby mode to the active mode.

10. The storage device according to claim 7, wherein
the management section of the second module turns off the management section of the first module, and is changed from the standby mode to the active mode.

11. The storage device according to claim 3, wherein
the management section in the active mode is provided with first identification information, the management section in the standby mode is provided with second identification information, and the management device recognizes the first identification information and accesses the management section in the active mode.

12. The storage device according to claim 5, wherein
at least one of the first and second adaptors, the cache memory, and the microprocessor can be in a power saving mode.

13. The storage device according to claim 12, wherein
the switches cannot be in the power saving mode.

14. A control method for a storage device configured to be able to modularize control resources for processing read and write commands coming from a computer with respect to storage resources, include at least one resulting module, and sequentially add any other resulting modules to the at least one resulting module, the method comprising the steps of:
setting any of management sections respectively provided to the plurality of modules for collective management with respect to the plurality of modules;
making a management user to access the set management section; and
allowing the management user to collectively manage the plurality of modules via the management section.
